(19) United States
(12) Patent Application Publication
(10) Pub. No.: US 2016/0219135 A1
(43) Pub. Date: Jul. 28, 2016

(54) RADIATOR FRAME HAVING ANTENNA PATTERN EMBEDDED THEREIN, ELECTRONIC DEVICE INCLUDING RADIATOR FRAME, AND METHOD OF MANUFACTURING RADIATOR FRAME

(71) Applicant: Samsung Electro-Mechanics Co., Ltd., Suwon-si (KR)

(72) Inventor: Sung Eun CHO, Suwon-si (KR)

(73) Assignee: Samsung Electro-Mechanics Co., Ltd., Suwon-si (KR)

(21) Appl. No.: 14/965,314

(22) Filed: Dec. 10, 2015

(30) Foreign Application Priority Data
Jan. 28, 2015 (KR) 10-2015-0013821

(51) Int. Cl. H04M 1/02

(52) U.S. Cl. CPC H04M 1/026

(57) ABSTRACT

A radiator frame includes: a radiator including an antenna pattern part configured to transmit or receive a signal and a terminal connection part configured to electrically connect the antenna pattern part and a circuit board to each other; a molding frame surrounding the radiator, wherein the antenna pattern part is exposed to a first surface of the molding frame and the terminal connection part is exposed to a second surface of the molding frame; and an extension frame formed separately from the molding frame and enclosing at least a portion of edges of the molding frame.

### CROSS-REFERENCE TO RELATED APPLICATION(S)

This application claims the benefit of Korean Patent Application No. 10-2015-0013821 filed on Jan. 28, 2015 in the Korean Intellectual Property Office, the entire disclosure of which is incorporated herein by reference for all purposes.

### BACKGROUND

1. Field

The following description relates to a radiator frame having an antenna pattern embedded therein and an electronic device including the same.

2. Description of Related Art

Recently, a method of using an injection-molding process to embed a radiator in a radiator frame and a method using two injection-molding processes to embed a radiator in an antenna pattern frame or an electronic device case have been used. That is, according to the related art, a method of forming a radiator frame by injection-molding the radiator frame around an antenna radiator and mechanically attaching the radiator frame to the electronic device case or integrating the radiator frame with the electronic device case by additional injection-molding has been used.

However, in a method including forming a radiator frame by performing injection-molding, a significant amount of time and effort may be required and manufacturing costs may be increased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a radiator frame includes: a radiator including an antenna pattern part configured to transmit or receive a signal, and a terminal connection part configured to electrically connect the antenna pattern part and a circuit board to each other; a molding frame surrounding the radiator, wherein the antenna pattern part is exposed to a first surface of the molding frame and the terminal connection part is exposed to a second surface of the molding frame; and an extension frame formed separately from the molding frame and enclosing at least a portion of edges of the molding frame.

The extension frame may be formed by injection-molding.

The extension frame may include a seating part to which the molding frame is configured to be fitted.

The seating part may include an opening having a same shape as a shape of the edges of the molding frame.

The seating part may include a recess having a same shape as a shape of the portion of the edges of the molding frame.

The molding frame may be configured to be slid and coupled to the seating part and may be configured to be fixed to the seating part by using an adhesive.

The molding frame may be configured to be fixed to the seating part by press-fitting.

The extension frame may be integrally molded with the molding frame.

The molding frame and the extension frame may be formed of a same material.

An electronic device may include: an electronic device case; the radiator frame mounted in the electronic device case; and the circuit board, wherein the circuit board is electrically connected to the terminal connection part and configured to receive a signal from the radiator or transmit a signal to the radiator.

According to another general aspect, a method of manufacturing a radiator frame includes: embedding a radiator in a molding frame by performing an injection-molding process; providing an extension frame that is formed separately from the molding frame; and enclosing at least a portion of edges of the molding frame in the extension frame.

Providing the extension frame may include performing an additional injection-molding process to form the extension frame.

Performing the additional injection-molding process may include integrally molding the extension frame with the molding frame.

The method may further include fitting the molding frame to a seating part of the extension frame.

The seating part may include an opening having a same shape as a shape of the edges of the molding frame.

The seating part may include a recess having a same shape as a shape of the portion of the edges of the molding frame.

Fitting the molding frame to the seating part may include sliding the molding frame into the seating part and fixing the molding frame to the seating part by using an adhesive.

Fitting the molding frame to the seating part may include fixing the molding frame to the seating part by press-fitting.

Other features and aspects will be apparent from the following detailed description, the drawings, and the claims.

### BRIEF DESCRIPTION OF THE DRAWINGS

FIG. 1 is a schematic perspective view illustrating a manner in which a radiator frame is coupled to a case of a mobile communications terminal, according to an embodiment.

FIG. 2 is a schematic exploded perspective view illustrating a mobile communications terminal manufactured using a radiator frame, according to an embodiment.

FIG. 3 is a schematic perspective view illustrating a radiator provided in a radiator frame, according to an embodiment.

FIG. 4 is a schematic perspective view illustrating a radiator frame, according to an embodiment.

FIG. 5 is a schematic cross-sectional view taken along line A-A′ of FIG. 4.

FIG. 6 is an exploded perspective view of a radiator frame which is separated into a molding frame and an extension frame, according to an embodiment.

FIG. 7 is an exploded perspective view of a radiator frame, according to another embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

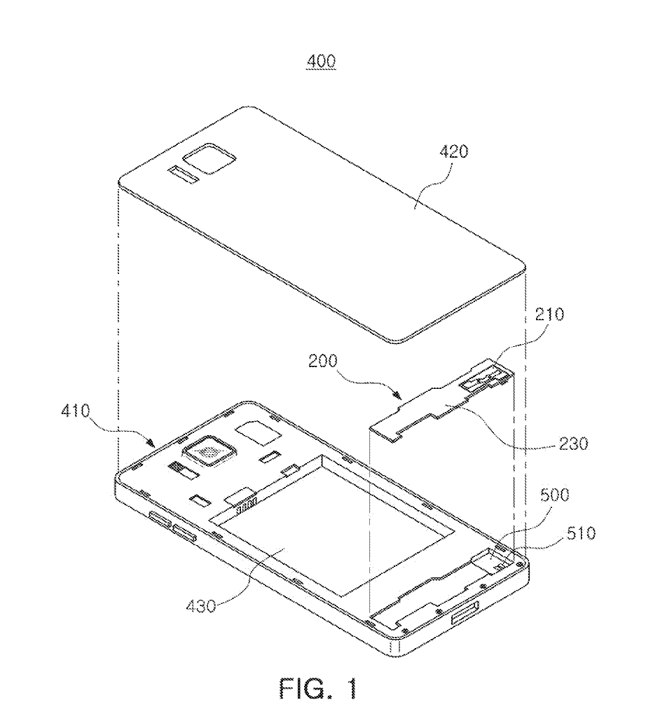

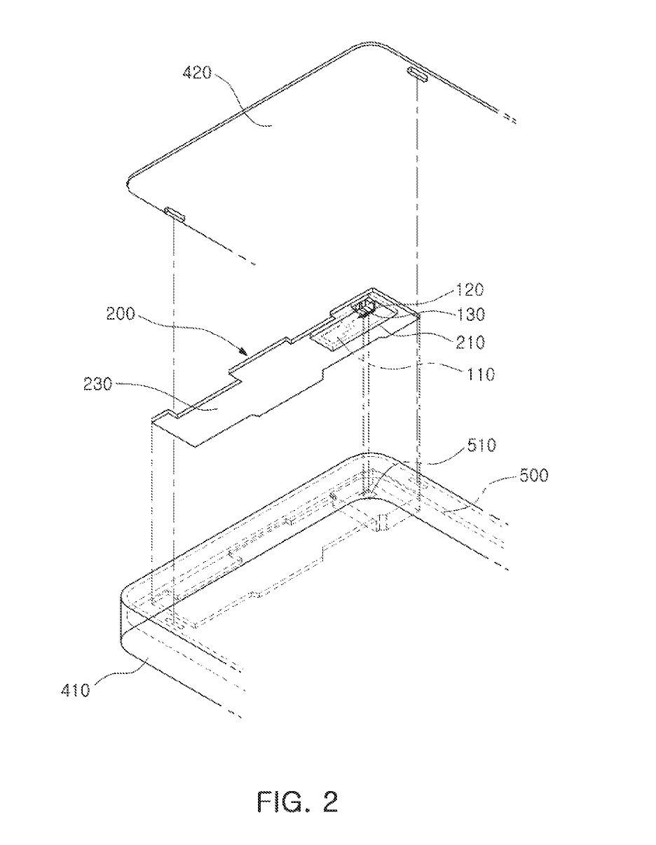

FIG. 1 is a schematic perspective view illustrating a manner in which a radiator frame 200 is coupled to a case 410 of a mobile communications terminal 400, which is an electronic device, according to an embodiment. FIG. 2 is a schematic exploded perspective view schematically illustrating the mobile communications terminal 400 manufactured using the radiator frame 200, according to an embodiment.

Referring to FIGS. 1 and 2, the mobile communications terminal 400 includes the case 410 forming an exterior of the terminal 400, and a battery cover 420 covering a battery mounting part 430 and the radiator frame 200.

The radiator frame 200 includes a molding frame 210 in which a radiator 100 is embedded, and an extension frame 230 surrounding outer edges of the molding frame 210. The molding frame 210 is formed by injection-molding a moldable material (e.g., a thermoplastic material) around the radiator 100, and the molding frame 210 may be slightly larger than the radiator 100, whereby a manufacturing yield and manufacturing reliability of the molding frame 210 may be improved.

Since a molding frame having an insufficient size may be supplemented with the extension frame 230 surrounding and extending from the outer edges of the molding frame 210, flexibility of production of a product may be increased, whereby productivity of the product may be improved. For example, the molding frame 210 may be formed by only adjusting a mold for an antenna shape that may be changed at any time without changing the shape of the extension frame 230, whereby the productivity of the product may be improved.

The radiator 100 includes a terminal connection part 130 configured to be connected to a terminal 510 of a circuit board 500. Thus, the radiator frame 200 may be mounted in the mobile communications terminal 400 such that the connection part 130 is connected to the terminal 510 and the radiator frame 200 thereby serves as an antenna in the mobile communications terminal 400.

In a case in which an antenna pattern part 110 is mounted in an electronic device such as the mobile communications terminal 400, or the like, when the radiator frame 200 is not covered with the battery cover 420, the antenna pattern part 110 may be exposed to an external environment. Therefore, a protective coating (not illustrated) may be provided on one surface of the radiator frame 200 to which the antenna pattern part 110 is exposed or on the antenna pattern part 110. For example, the protective coating may be immediately formed by spraying a liquid by painting, or the like, or may be simply formed by attaching a ready-made article such as a film, a coating, or the like.

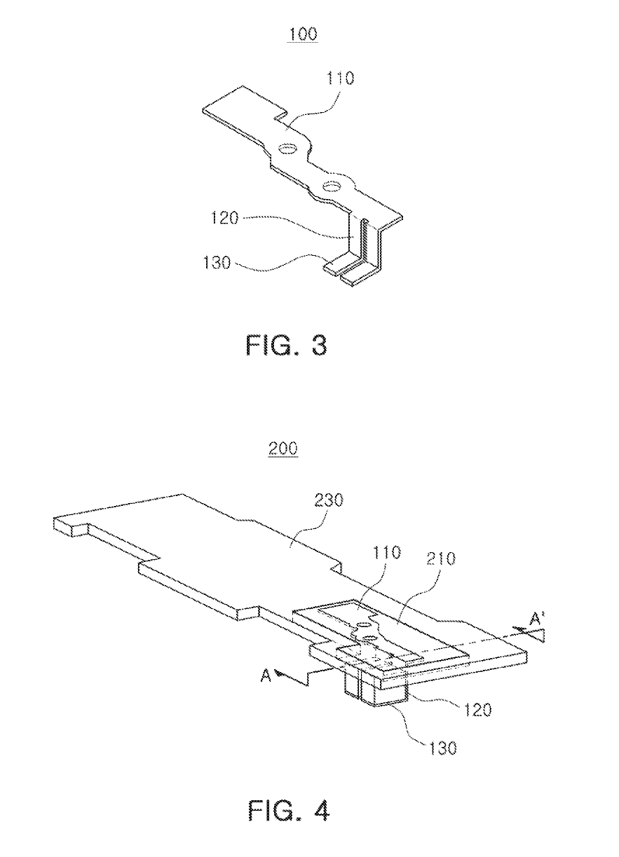

FIG. 3 is a schematic perspective view illustrating the radiator 100 according to an embodiment.

As shown in FIG. 3, the radiator 100 includes the antenna pattern part 110 configured to transmit or receive signals, a connecting part 120, and the terminal connection part 130 configured to allow the signals to be transmitted to or received from the circuit board 500. The radiator 100 is formed of a conductive material such as aluminum, copper, or the like, and is configured to receive external signals and transmit the received signals to a signal processing device of the mobile communications terminal 400. In addition, the antenna pattern part 110 forms a meandering line in order to receive external signals in various bands.

In addition, the antenna pattern part 110 and the terminal connection part 130 are connected to each other by the connecting part 120, and the antenna pattern part 110 and the terminal connection part 130 are bent with respect to each other such that the radiator 100 has a three-dimensional structure. More specifically, the connecting part 120 connects the antenna pattern part 110 and the terminal connection part 130 to each other such that the antenna pattern part 110 is formed on one surface of the molding frame 210 and the terminal connection part 130 is formed on the other surface of the molding frame 210 that opposes the one surface of the molding frame 210.

The terminal connection part 130 transmits signals received by the antenna pattern part 110 to the circuit board 500 or transmits signals to be transmitted externally from the circuit board 500 to the antenna pattern part 110, and elastically contacts the terminal 510 of the circuit board 500 in order to provide a reliable connection between the terminal connection part 130 and the terminal 510, and thereby provide reliability in transmitting the signals.

A component for providing elastic force may be added to the terminal connection part 130. That is, after the radiator frame 200 in which the antenna pattern 110 is embedded is injection-molded, external force may be applied to the terminal connection part 130 to bend the terminal connection part 130 in order to provide elasticity to the terminal connection part 130. In this case, a reinforcing member (not illustrated) such as a reinforcing embossing, or the like, may be formed on a boundary between the connecting part 120 and the terminal connection part 130, thereby providing the elastic force of the terminal connection part 130.

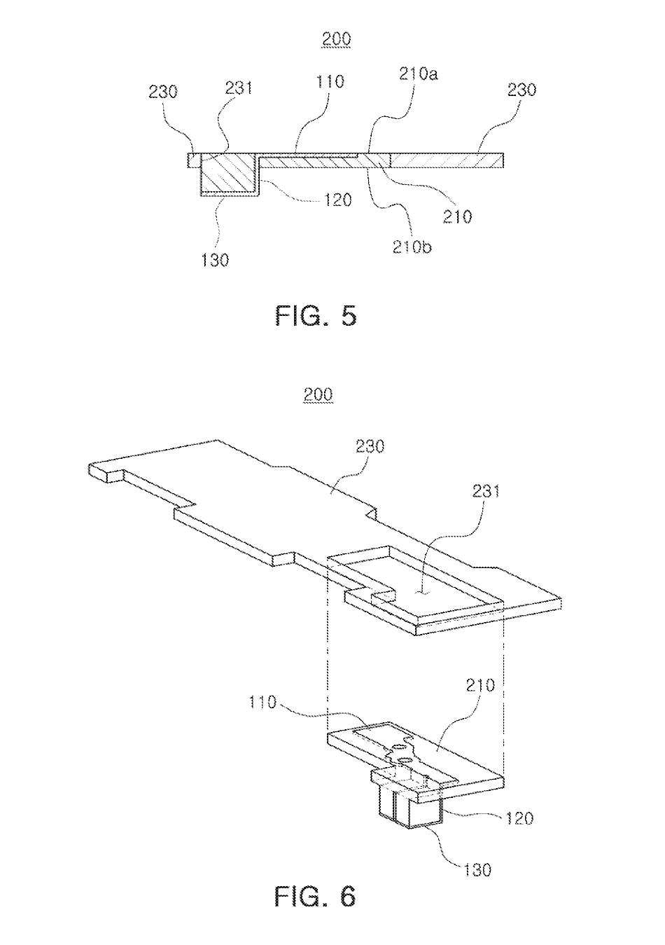

Referring to FIGS. 4 through 6, as described above, the radiator frame 200, according to an embodiment, includes the radiator 100, the molding frame 210, and the extension frame 230. FIG. 4 is a schematic perspective view illustrating the radiator frame 200 according to an embodiment. FIG. 5 is a schematic cross-sectional view taken along line A-A′ of FIG. 4. FIG. 6 is an exploded perspective view of the radiator frame 200 with the molding frame 210 and the extension frame 230 separated from each other.

As discussed above, the molding frame 210 is manufactured by injection-molding the radiator 100, and the connection terminal 130 has elasticity. That is, when the injection-molding to embed the radiator 100 in the molding frame 210 is completed, the terminal connection part 130 is rotated and bent to be spaced apart from the molding frame 210. In this case, since an elastic body is provided as the radiator 100, the terminal connection part 130 naturally has elasticity. Since other structures for reinforcing the elastic force have been described above in detail, further descriptions thereof will be omitted.

The antenna pattern part 110 is formed on one surface 210a of the molding frame 210, and the terminal connection part 130 is formed on another surface 210b of the molding frame 210 that opposes the surface 210a. Also, as previously described, the extension frame 230 surrounds and encloses the outer edges of the molding frame 210.

The extension frame 230 is manufactured separately from the molding frame 210 by, for example, injection-molding. However, the extension frame 230 is not limited to being manufactured by injection-molding, but may be manufactured by various manufacturing methods. In addition, the extension frame 230 includes a seating part 231 to which the molding frame 210 is fitted. The seating part 231 is, for example, an opening in the extension frame 230 and has the same shape as that of the edge of the molding frame 210.

The molding frame 210 may be fitted into and attached to the seating part 231 of the extension frame 230. For example, the molding frame 210 may be slid and coupled to the seating part 231 and may then be fixed to the seating part 231 by using an adhesive or may be fixed to the seating part 231 by press-fitting. Also, in case in which the molding frame 210 is press-fitted into the seating part 231, additional bonding may be performed by applying an adhesive to secure the molding frame 210 in the seating part 231.

Alternatively, the extension frame 230 may be manufactured by injection-molding a molding material for the extension frame 230 around the molding frame 210. In this case, the extension frame 230 is formed integrally with the molding frame 210 is manufactured by fixing the molding frame 210, which is manufactured in advance, to a mold and injecting an injection-molding solution into the mold. In addition, the injection-molding solution may be injected to entirely enclose the outer edges of the molding frame 210, such that the radiator frame 200 having the extension frame 230 enclosing the entire edge of the molding frame 210 is formed. The injection-molding solutions used for manufacturing the molding frame 210 and the extension frame 230 may be formed of the same material.

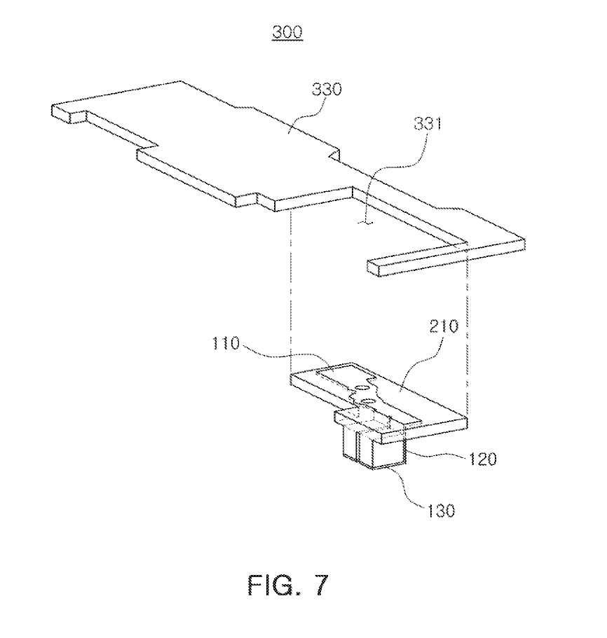

FIG. 7 is an exploded perspective view of a radiator frame 300 according to another embodiment.

As shown in FIG. 7, the radiator frame 300 includes an extension frame 330 enclosing the outer edges of the molding frame 210. In this case, the extension frame 330 includes a seating part 331 that is a recess in an edge or a corner of the extension frame 330. The seating part 331 may have the same shape as that of a portion of the outer edges of the molding frame 210.

In addition, the molding frame 210 may be fitted into and attached to the seating part 331. For example, the molding frame 210 may be slid and coupled to the seating part 331 and be then fixed to the seating part 331 by using an adhesive, or may be fixed to the seating part 331 by press-fitting. Also, in case in which the molding frame 210 is press-fitted into the seating part 331, additional bonding may be performed by applying an adhesive to secure the molding frame 210 in the seating part 331.

Alternatively, the extension frame 230 may be manufactured by injection-molding a molding material for the extension frame 330 around the molding frame 210. In this case, the extension frame 330 is formed integrally with the molding frame 210 and is manufactured by fixing the molding frame 210, which is manufactured in advance, to a mold and injecting an injection-molding solution into the mold. In addition, the injection-molding solution may be injected to enclose a portion of the outer edges of the molding frame 210, such that the radiator frame 300 having the extension frame 330 enclosing the portion of the outer edges of the molding frame 210 is formed. The injection-molding solutions used for manufacturing the molding frame 210 and the extension frame 330 may be formed of the same material.

As set forth above, according to the embodiments disclosed herein, a radiator frame having high reliability and good manufacturing yields through a simple structural change may be provided.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A radiator frame comprising:
a radiator comprising an antenna pattern part configured to transmit or receive a signal, and a terminal connection part configured to electrically connect the antenna pattern part and a circuit board to each other;
a molding frame surrounding the radiator, wherein the antenna pattern part is exposed to a first surface of the molding frame and the terminal connection part is exposed to a second surface of the molding frame; and
an extension frame formed separately from the molding frame and enclosing at least a portion of edges of the molding frame.

2. The radiator frame of claim 1, wherein the extension frame is formed by injection-molding.

3. The radiator frame of claim 2, wherein the extension frame comprises a seating part to which the molding frame is configured to be fitted.

4. The radiator frame of claim 3, wherein the seating part comprises an opening having a same shape as a shape of the edges of the molding frame.

5. The radiator frame of claim 3, wherein the seating part comprises a recess having a same shape as a shape of the portion of the edges of the molding frame.

6. The radiator frame of claim 3, wherein the molding frame is configured to be slid and coupled to the seating part and is configured to be fixed to the seating part by using an adhesive.

7. The radiator frame of claim 3, wherein the molding frame is configured to be fixed to the seating part by press-fitting.

8. The radiator frame of claim 2, wherein the extension frame is integrally molded with the molding frame.

9. The radiator frame of claim 8, wherein the molding frame and the extension frame are formed of a same material.

10. An electronic device comprising:
an electronic device case;
the radiator frame of claim 1 mounted in the electronic device case; and
the circuit board, wherein the circuit board is electrically connected to the terminal connection part and configured to receive a signal from the radiator or transmit a signal to the radiator.

11. A method of manufacturing a radiator frame, comprising:
embedding a radiator in a molding frame by performing an injection-molding process;
providing an extension frame that is formed separately from the molding frame; and
enclosing at least a portion of edges of the molding frame in the extension frame.

12. The method of claim 11, wherein providing the extension frame comprises performing an additional injection-molding process to form the extension frame.

13. The method of claim 12, wherein performing the additional injection-molding process comprises integrally molding the extension frame with the molding frame.

14. The method of claim 11, further comprising fitting the molding frame to a seating part of the extension frame.

15. The method of claim 14, wherein the seating part comprises an opening having a same shape as a shape of the edges of the molding frame.

16. The method of claim 14, wherein the seating part comprises a recess having a same shape as a shape of the portion of the edges of the molding frame.

17. The method of claim 14, wherein fitting the molding frame to the seating part comprises sliding the molding frame into the seating part and fixing the molding frame to the seating part by using an adhesive.

18. The method of claim 14, wherein fitting the molding frame to the seating part comprises fixing the molding frame to the seating part by press-fitting.
